(19) United States
(12) Patent Application Publication
(10) Pub. No.: US 2016/0161332 A1
(43) Pub. Date: Jun. 9, 2016

(54) IMAGE SENSOR USING PIXELS WITH COMBINED RGB AND IR SENSING

(71) Applicant: STMicroelectronics (Research & Development) Limited, Marlow (GB)

(72) Inventor: Christopher Townsend, Edinburgh (GB)

(73) Assignee: STMicroelectronics (Research & Development) Limited, Marlow (GB)

(21) Appl. No.: 14/564,807

(22) Filed: Dec. 9, 2014

(51) Int. Cl. G01J 1/04; G02B 5/20; G02B 5/28; G01J 1/44

(52) U.S. Cl. CPC G01J 1/0492; G01J 1/44; G02B 5/201; G02B 5/281

(57) ABSTRACT

A sensor system includes an array of pixels, each pixel including a first pixel and a second pixel. A first color filter provided over the first pixel is configured to pass a first color portion within and less than a visible portion of the spectrum. An infra-red color filter provided over the second pixel is configured to pass a near infra-red portion and an infra-red portion of the spectrum, but not the visible portion of the spectrum. An interference filter is provided over the first and second pixels, wherein the interference filter is configured to pass the visible portion of the spectrum and the near infra-red portion of the spectrum. The first pixel detects light sensed in the first color portion and the second pixel detects light sensed in the near infra-red portion. A processing circuit corrects the sensed first color portion as a function of the sensed near-infra-red portion.

### TECHNICAL FIELD

The present invention relates to an image sensor and, more particularly, to an image sensor with pixels configured to sense multiple colors of visible light as well as infra-red/near infra-red light.

### BACKGROUND

Reference is made to FIG. 1. A conventional color image sensor utilizes a Bayer pattern of pixels and pixel filters wherein a sensor pixel 10 comprises a 2×2 sub-array of pixels including a red (R) pixel 12, two green (G) pixels 14 and 16 and a blue (B) pixel 18. A pixelated imaging array 20 is formed by arranging a plurality of color sensor pixels 10 in a matrix of rows and columns as shown in FIG. 2. Each color pixel (12-18) within sensor pixel 10 includes a substrate 30 within which a photodiode 32 (or other CMOS semiconductor sensing structure) is formed with a color filter layer 34 and optical lens 36 disposed over the photodiode 32 as shown in FIG. 3. The characteristics of the color filter layer 34 depend on whether the photodiode 32 is provided for a red pixel 12, green pixel 14 or 16 or blue pixel 18, with each filter layer 34 designed to pass a specific visible light region or band of the spectrum. The optical lens 36 may comprise one or more of a micro-lens provided for the individual pixel 12-18 itself and a macro-lens provided for the entire array 20.

The color filter layer 34 not only passes the range of wavelengths of the visible light portion of the spectrum associated with the color of the pixel (i.e., red, green or blue) but may also pass wavelengths of light in the infra-red (IR) or near infra-red (NIR) region or band of the spectrum. This is especially the case for the red pixel 12. The response of the photodiode 32 to IR or NIR wavelengths may be comparable to the response of the photodiode to visible light in the specific visible color range. Thus, the IR or NIR light received by each photodiode 32 may adversely affect the ability of the sensor to sense the desired visible light. This phenomenon is known in the art as IR/NIR contamination and is responsible for, among other issues, washing-out of the color response of the photodiode 32 in the visible spectrum.

There is a need in the art to address this and other problems associated the reception of IR/NIR wavelengths in color imaging sensors.

### SUMMARY

In an embodiment, a sensor pixel comprises: a sub-array of color pixels including a first pixel and a second pixel; a red color filter over the first pixel; an infra-red color filter over the second pixel; an interference filter over the first and second pixels; wherein the red color filter includes a first transmission pass band passing a region of the spectrum above a first wavelength; wherein the infra-red color filter includes a second transmission pass band passing a region of the spectrum above a second wavelength, the second wavelength being greater than the first wavelength; and wherein the interference filter includes a third transmission pass band passing a region of the spectrum below a third wavelength, the third wavelength being greater than the second wavelength.

In an embodiment, a sensor system comprises: an array of sensing elements, wherein each sensing element comprises a sub-array of sensor pixels including a first pixel configured to sense primarily a first visible color and a second pixel configured to sense primarily in an infra-red color above a first wavelength of the spectrum; an interference filter above the array of sensing elements, the interference filter having a transmission pass band passing a region of the spectrum below a second wavelength, the second wavelength being greater than the first wavelength; and wherein the first pixel is further configured to generate a first color value indicative of sensing the first visible color; wherein the second pixel is configured to generate an infra-red color value indicative of sensing in a sensing region of the spectrum between the first and second wavelengths; and a processing circuit configured to receive configured to receive the first color value and infra-red color value and calculate a corrected first color value as a function of a difference between the first color value and the infra-red color value.

In an embodiment, a method comprises: sensing with a first pixel of a sub-array of color pixels radiation in a first region of the spectrum between a first wavelength and a second wavelength, wherein the first wavelength is set by a first color filter for the first pixel, and wherein the second wavelength is set by an interference filter for the sub-array of color pixels; generating a first color value indicative of sensing the first region; sensing with a second pixel of a sub-array of color pixels radiation in a second region of the spectrum between a third wavelength and the second wavelength, wherein the third wavelength is set by an infra-red color filter for the second pixel, and wherein the third wavelength is greater than the first wavelength and less than the second wavelength; generating an infra-red color value indicative of sensing the second region; and calculating a corrected first color value as a function of a difference between the first color value and the infra-red color value.

In an embodiment, a sensor system comprises: a sub-array of color pixels including a first pixel and a second pixel; an interference filter over the first and second pixels, wherein the interference filter is configured to pass a visible portion of the spectrum and a near infra-red portion of the spectrum; a first color filter over the first pixel, wherein the first color filter is configured to pass a first color portion within and less than the visible portion of the spectrum; and an infra-red color filter over the second pixel, wherein the infra-red color filter is configured to pass the near infra-red portion and infra-red portion of the spectrum but not the visible portion of the spectrum.

### BRIEF DESCRIPTION OF THE DRAWINGS

For a better understanding of the embodiments, reference will now be made by way of example only to the accompanying figures in which:

FIG. 1 is a schematic illustration of the color pixel layout for a conventional sensor pixel sub-array;

FIG. 2 is a schematic illustration of a sensor array including the sensor pixel sub-arrays of FIG. 1;

FIG. 3 is a cross-sectional schematic of an individual color pixel;

FIG. 4 is a schematic illustration of a color pixel layout in an embodiment;

FIG. 5 is a schematic illustration of a sensor array including the sensor pixel sub-arrays of FIG. 4;

FIG. 6 is a cross-sectional schematic of an individual pixel of the pixel sub-array; and

FIGS. 7A-7D illustrate transmission characteristics for visible light filters, infra-red light filters and an interference filter of the individual pixels of the pixel sub-array.

### DETAILED DESCRIPTION OF THE DRAWINGS

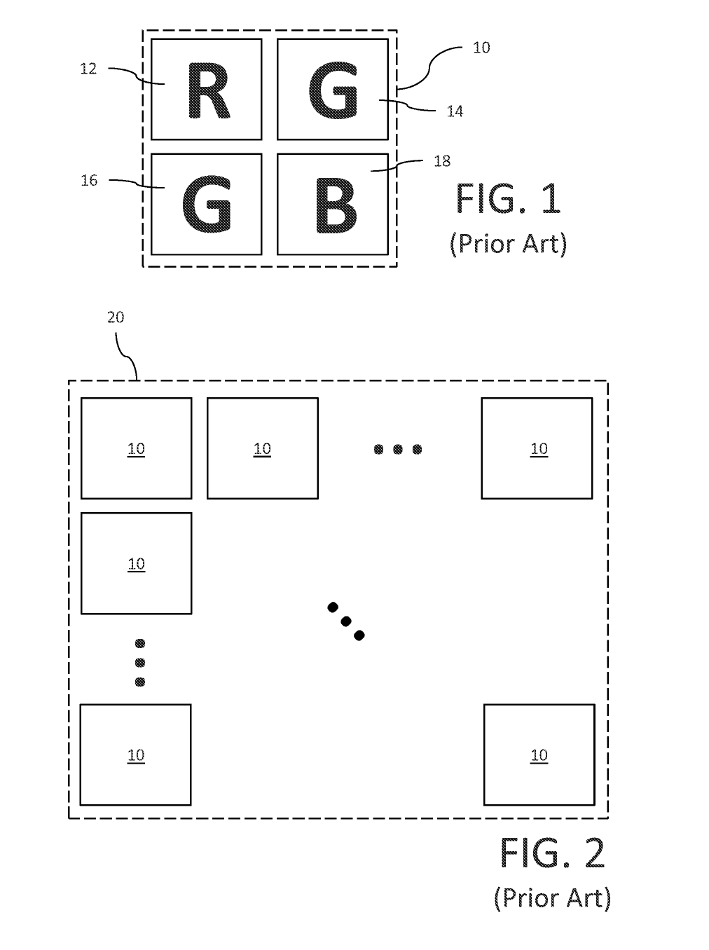

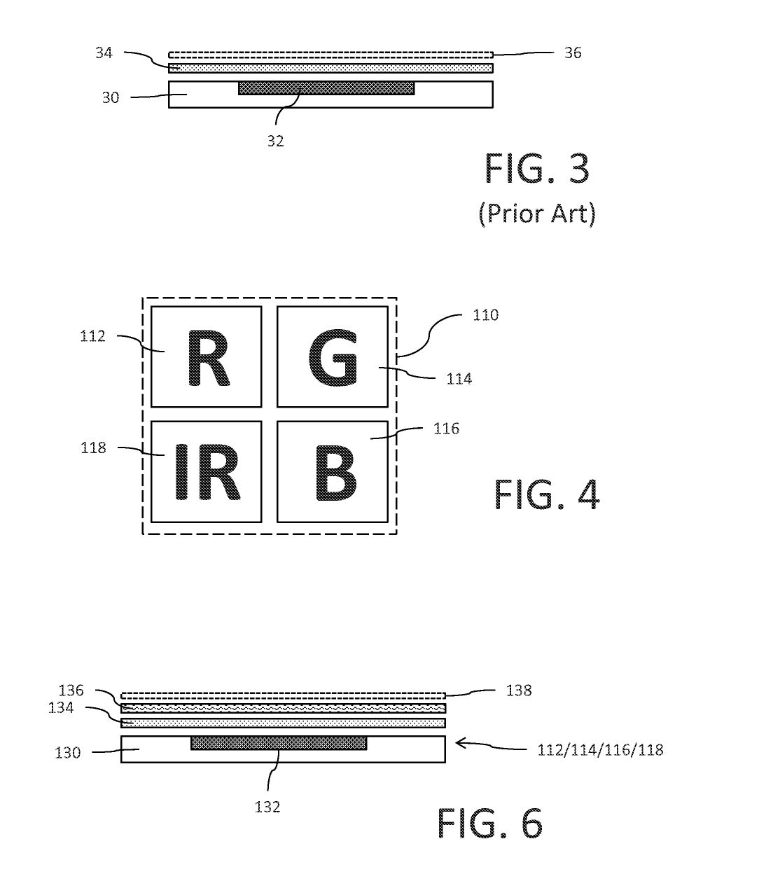

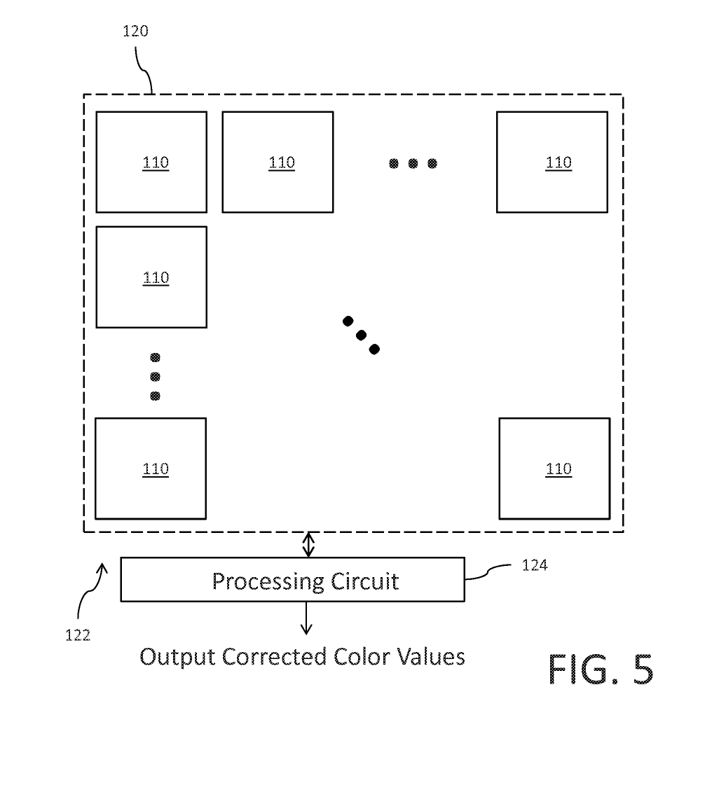

Reference is now made to FIG. 4 showing a schematic illustration of a color pixel layout in an embodiment. This layout presents a modification of the conventional Bayer pattern (see, FIG. 1) of pixels and pixel filters. A sensor pixel 110 comprises a 2×2 sub-array of pixels including a red pixel 112, a green pixel 114, a blue pixel 116 and an infra-red pixel 118. A pixelated imaging array 120 is formed by arranging a plurality of color sensor pixels 110 in a matrix of rows and columns as shown in FIG. 5.

The infra-red pixel 118 is shown in FIG. 4 occupying the bottom left corner of the sub-array diagonally opposite the green pixel 114, but it will be understood that the infra-red pixel 118 could be placed in any corner of the sub-array diagonally opposite any of the red pixel 112, green pixel 114, or blue pixel 116.

Each color pixel 112-116 for visible light sensing, as well as the color pixel 118 for infra-red and/or near infra-red (IR/NIR) sensing, includes a substrate 130 within which a photodiode 132 (or other CMOS semiconductor sensing structure) is formed with a color filter layer 134, an interference filter layer 136 and optical lens 138 disposed over the photodiode 32 as shown in FIG. 6. The characteristics of the color filter layer 134 depend on whether the photodiode 132 is provided for a red pixel 112 (designed to primarily detect red light), green pixel 114 (designed to primarily detect green light), a blue pixel 116 (designed to primarily detect blue light) or an IR/NIR pixel 118 (designed to primarily detect IR/NIR light), with each filter layer 134 designed to pass a specific region or band of the spectrum.

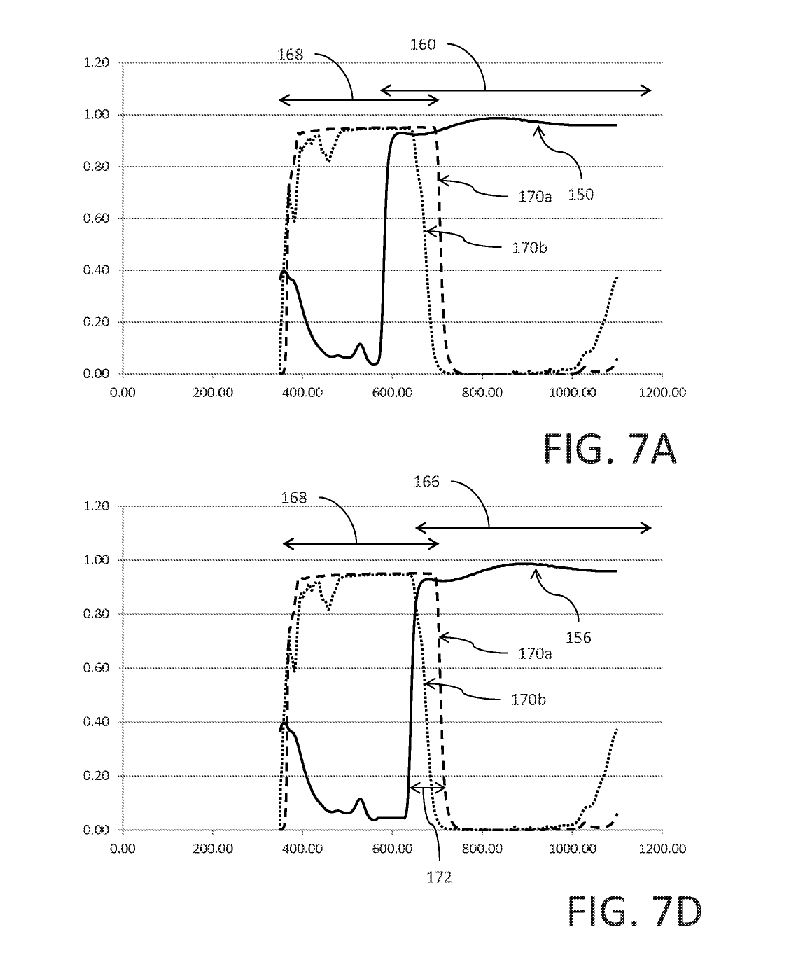

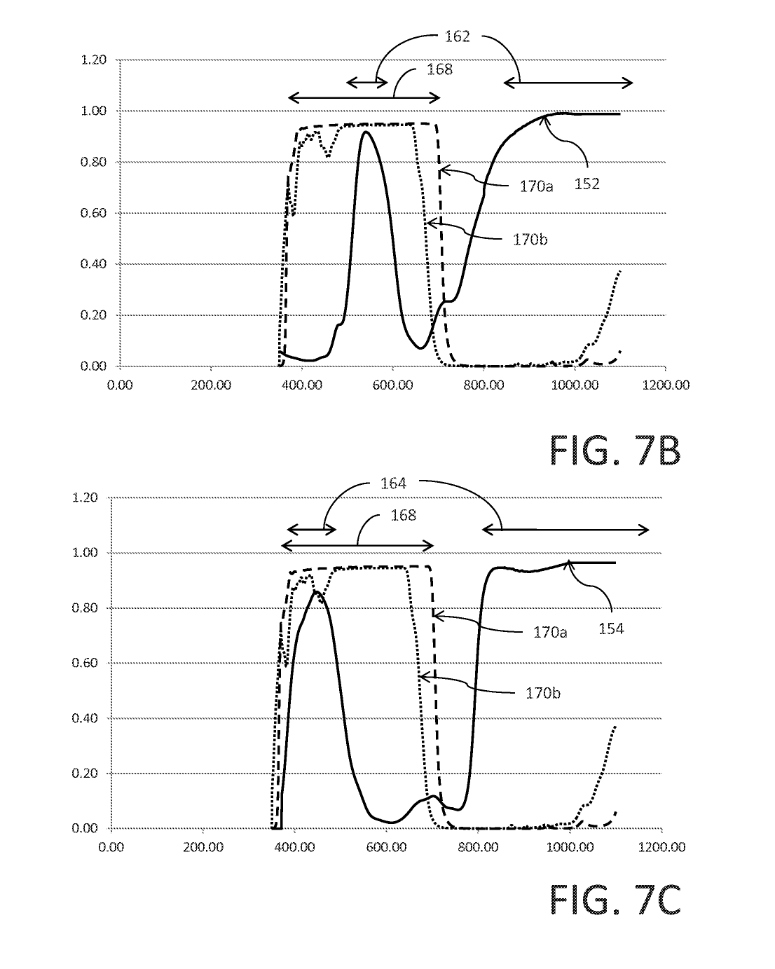

FIG. 7A illustrates the red light transmission characteristics 150 versus wavelength for an example of the filter layer 134 used for the red pixel 112. It will be noted that the filter layer 134 for the red pixel includes a pass band 160 which permits light with wavelengths greater than about 580 nm (+/−5%) to pass (i.e., the filter allows visible red, near infra-red and infra-red light to pass).

FIG. 7B illustrates the green light transmission characteristics 152 versus wavelength for an example of the filter layer 134 used for the green pixel 114. It will be noted that the filter layer 134 for the green pixel includes a pass band 162 which permits light with wavelengths between 500-600 nm (+/−5%) and greater than about 800 nm to pass (i.e., the filter allows visible green and infra-red light to pass).

FIG. 7C illustrates the blue light transmission characteristics 154 versus wavelength for an example of the filter layer 134 used for the blue pixel 116. It will be noted that the filter layer 134 for the blue pixel includes a pass band 164 which permits light with wavelengths between 400-500 nm (+/−5%) and greater than about 800 nm to pass (i.e., the filter allows visible blue and infra-red light to pass).

FIG. 7D illustrates the IR/NIR light transmission characteristics 156 versus wavelength for an example of the filter layer 134 used for the IR/NIR pixel 118. It will be noted that the filter layer 134 for the IR/NIR pixel includes a pass band 166 which permits light with wavelengths greater than about 650 nm (+/−5%) to pass (i.e., the filter allows near infra-red and infra-red light to pass).

The transmission characteristic of the interference filter layer 138 substantially blocks the IR region or band of the spectrum but otherwise is transparent to the visible light region or band of the spectrum as well as the near infra-red region or band of the spectrum. FIGS. 7A-7D illustrate the interference light transmission characteristics 170a and 170b versus wavelength for an example of the interference filter layer 136 for the red pixel 112, green pixel 114, blue pixel 116 and IR/NIR pixel 118. Reference 170a provides the transmission characteristics at 0 degrees, while reference 170b provides the transmission characteristics at 35 degrees. In this regard, it will be understood that the transmission characteristics vary as a function of the incident angle of light, with the 0 degrees showing the characteristics for on axis light and 35 degrees showing the characteristics for off axis light and referring to an example of a maximum off axis angle for a camera system. It will be noted that the interference filter layer 136 includes a pass band 168 which permits visible light and near infra-red light with wavelengths between 380-700 nm to pass. Thus, with respect to the IR/NIR pixel 118, the combined light transmission characteristics of the filter layer 134 used for the IR/NIR pixel 118 and the interference filter layer 136 will permit only near infra-red light with wavelength between 650-700 nm to reach the photodiode 132 (as indicated at reference 172 in FIG. 7B).

Those skilled in the art recognize that a conventional interference filter for a visible camera has an upper cut-off at around 650 nm (on-axis). This poses a problem for high angle light where the cut-off shifts left (i.e., <650 nm) and thus starts to remove wanted visible light. In the embodiments disclosed herein, the upper cut-off for the interference filter 136 is instead selected at, for example, 700 nm so that even at high angles the filter does not remove visible light (i.e., off-axis the cut-off is still >650 nm). This higher cut-off will let pass near infrared radiation, but this issue is accounted for and corrected using the process discussed below with information obtained by the IR sensor. In the disclosed embodiment, 650 nm represents the maximum wavelength of what is considered to be “wanted” light. The placement of the cutoff at 700 nm is by example only, it being understood that other cutoff values near 700 nm, for example, 710-720 nm, could alternatively be selected. What is important is that the selected value for the upper cutoff (for example, in the range of 700-740 nm) be high enough such that the angular shift of the filter 136 does not shift into the wanted wavelength region of 650 nm and cutoff wanted light.

The optical lens 138 may comprise one or more of a micro-lens provided for the individual pixel 112-118 itself and a macro-lens provided for the entire array 120.

Reference is once again made to FIG. 5. The pixelated imaging array 120 is a component of an imaging system 122 that further includes a processing circuit 124. The processing circuit reads color values from each sensor pixel 110 of the array 120. The color values include a red color value (RED_{uncorrected}) from the red pixel 112, a green color value (GREEN_{uncorrected}) from the green pixel 114, a blue color value (BLUE_{uncorrected}) from the blue pixel 116, and an infra-red color value (IR) from the IR/NIR pixel 118. Corrected color values are then calculated by the processing circuit 124 as follows:

RED_{corrected}=RED_{uncorrected}−α_{red}*IR

GREEN_{corrected}=GREEN_{uncorrected}−α_{green}*IR

BLUE_{corrected}=BLUE_{uncorrected}−α_{blue}*IR

In the foregoing calculations, the IR value represents the near infra-red light (wavelength between 650-700 nm) contamination sensed by the IR/NIR pixel 118, where that light also contributes to the red color value (RED_{uncorrected}) sensed by the red pixel 112, and may further contribute to the green color value (GREEN_{uncorrected}) sensed by the green pixel 114 and blue color value (BLUE_{uncorrected}) sensed by the blue pixel 116. The correction performed subtracts the IR/NIR contamination to generate the corrected pixel values. Because of differences in sensitivity of the red pixel 112, green pixel 114 and blue pixel 116 to this IR/NIR contamination, the correction factors α_{red}, α_{green} and α_{blue} will most likely be different. Indeed, in some implementations, the green and blue corrections may not be required at all (i.e., GREEN_{corrected}=GREEN_{uncorrected} and BLUE_{corrected}=BLUE_{uncorrected}).

The interference filter layer 136 may, for example, comprise a substrate (for example, made of glass) coated with multiple layers of materials having differing refractive indices. The number of layers, the layer thicknesses and the material for each layer are selected to control the transmission characteristics of the filter. Those skilled in the art understand how to design and build an interference layer 136 have the transmission characteristics (references 170a and 170b) as shown in FIGS. 7A-7D.

Although making and using various embodiments are discussed in detail herein, it should be appreciated that as described herein are provided many inventive concepts that may be embodied in a wide variety of contexts. Embodiments discussed herein are merely representative and do not limit the scope of the invention.

While the invention has been illustrated and described in detail in the drawings and foregoing description, such illustration and description are considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

What is claimed is:

1. A sensor pixel, comprising:
a sub-array of color pixels including a first pixel and a second pixel;
a red color filter over the first pixel;
an infra-red color filter over the second pixel;
an interference filter over the first and second pixels;
wherein the red color filter includes a first transmission pass band passing a region of the spectrum above a first wavelength;
wherein the infra-red color filter includes a second transmission pass band passing a region of the spectrum above a second wavelength, the second wavelength being greater than the first wavelength; and
wherein the interference filter includes a third transmission pass band passing a region of the spectrum below a third wavelength, the third wavelength being greater than the second wavelength.

2. The sensor pixel of claim 1, wherein the first pixel is configured to generate a red color value indicative of light sensed in a first sensing region of the spectrum between the first and third wavelengths; and wherein the second pixel is configured to generate an infra-red color value indicative of light sensed in a second sensing region of the spectrum between the second and third wavelengths.

3. The sensor pixel of claim 2, further comprising a processing circuit configured to receive the red color value and infra-red color value and calculate a corrected red color value as a function of a difference between the red color value and the infra-red color value.

4. The sensor pixel of claim 3, wherein the processing circuit is configured to calculate the corrected red color value in accordance with the following formula:
corrected red color value=red color value−(α*infra-red color value);
wherein α is a scaling factor.

5. The sensor pixel of claim 1, wherein the sub-array of color pixels further includes a third pixel and a fourth pixel, further comprising:
a blue color filter over the third pixel; and
a green color filter over the fourth pixel;
wherein the interference filter is further over the third and fourth pixels.

6. The sensor pixel of claim 1,
wherein the first wavelength is approximately 580 nm;
wherein the second wavelength is approximately 650 nm; and
wherein the third wavelength is approximately 700 nm.

7. A sensor system, comprising:
an array of sensing elements, wherein each sensing element comprises a sub-array of sensor pixels including a first pixel configured to sense primarily a first visible color and a second pixel configured to sense primarily in an infra-red color above a first wavelength of the spectrum;
an interference filter above the array of sensing elements, the interference filter having a transmission pass band passing a region of the spectrum below a second wavelength, the second wavelength being greater than the first wavelength; and
wherein the first pixel is further configured to generate a first color value indicative of sensing the first visible color;
wherein the second pixel is configured to generate an infra-red color value indicative of sensing in a sensing region of the spectrum between the first and second wavelengths; and
a processing circuit configured to receive configured to receive the first color value and infra-red color value and calculate a corrected first color value as a function of a difference between the first color value and the infra-red color value.

8. The sensor system of claim 7, wherein the processing circuit is calculates the corrected first color value in accordance with the following formula:
corrected first color value=first color value−(α*infra-red color value);
wherein α is a scaling factor.

9. The sensor system of claim 7, wherein the sub-array of color pixels further includes a third pixel configured to sense primarily a third visible color and a fourth pixel configured to sense primarily a fourth visible color, wherein the interference filter is further over the third and fourth pixels.

10. The sensor system of claim 7,
wherein the first wavelength is approximately 650 nm; and
wherein the second wavelength is approximately 700 nm.

11. The sensor system of claim 7, wherein the first visible color is red.

12. A method, comprising:
sensing with a first pixel of a sub-array of color pixels radiation in a first region of the spectrum between a first wavelength and a second wavelength, wherein the first wavelength is set by a first color filter for the first pixel, and wherein the second wavelength is set by an interference filter for the sub-array of color pixels;
generating a first color value indicative of sensing the first region;
sensing with a second pixel of a sub-array of color pixels radiation in a second region of the spectrum between a third wavelength and the second wavelength, wherein the third wavelength is set by an infra-red color filter for the second pixel, and wherein the third wavelength is greater than the first wavelength and less than the second wavelength;
generating an infra-red color value indicative of sensing the second region; and
calculating a corrected first color value as a function of a difference between the first color value and the infra-red color value.

13. The method of claim 12, wherein calculating comprises calculating the corrected first color value in accordance with the following formula:
corrected first color value=first color value−(α*infra-red color value);
wherein α is a scaling factor

14. The method of claim 12, further comprising:
sensing with a third pixel of the sub-array of color pixels radiation in a third region of the spectrum below the first wavelength; and
sensing with a fourth pixel of the sub-array of color pixels radiation in a fourth region of the spectrum below the third region.

15. The method of claim 14, wherein the first region is primarily red light, the second region is primarily green light and the third region is primarily blue light.

16. The method of claim 12,
wherein the first wavelength is approximately 580 nm;
wherein the second wavelength is approximately 650 nm; and
wherein the third wavelength is approximately 700 nm.

17. The method of claim 14, wherein the first region is primarily red light.

18. A sensor system, comprising:
a sub-array of color pixels including a first pixel and a second pixel;
an interference filter over the first and second pixels, wherein the interference filter is configured to pass a visible portion of the spectrum and a near infra-red portion of the spectrum;
a first color filter over the first pixel, wherein the first color filter is configured to pass a first color portion within and less than the visible portion of the spectrum; and
an infra-red color filter over the second pixel, wherein the infra-red color filter is configured to pass the near infra-red portion and infra-red portion of the spectrum but not the visible portion of the spectrum.

19. The sensor system of claim 18, wherein the first pixel is configured to generate a first color value indicative of light sensed in the first color portion; and wherein the second pixel is configured to generate an infra-red color value indicative of light sensed in the near infra-red portion.

20. The sensor system of claim 19, further comprising a processing circuit configured to receive first red color value and infra-red color value and calculate a corrected first color value as a function of a difference between the first color value and the infra-red color value.

21. The sensor system of claim 3, wherein the processing circuit is configured to calculate the corrected first color value in accordance with the following formula:
corrected first color value=first color value−(α*infra-red color value);
wherein α is a scaling factor.
